(19) United States
(12) Patent Application Publication
(10) Pub. No.: US 2008/0010494 A1
(43) Pub. Date: Jan. 10, 2008

(54) Raid control device and failure monitoring method

(75) Inventor: Keiju Takizawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/500,514

(22) Filed: Aug. 8, 2006

(30) Foreign Application Priority Data
Apr. 28, 2006 (JP) 2006-126806

(51) Int. Cl. G06F 11/00

(52) U.S. Cl. 714/5

(57) ABSTRACT

A redundant-array-of-independent-disks control device includes a plurality of control modules and a switch for connecting the control modules. Each of the control modules includes a failure monitoring unit that sends a check command for detecting a possible failure to other control modules via a predetermined path, and specifies a region suspected to be in failure based on a response to the check command and a status of a path or a region on the path indicated by the response.

### BACKGROUND OF THE INVENTION

1. Field of the Invention

The present invention relates to a redundant-array-of-independent-disks (RAID) control device and a failure monitoring method with a capability of specifying a region suspected to be in failure even when it is not possible to secure sufficient number of monitoring paths.

2. Description of the Related Art

Conventionally, in an information processing system in which high reliability is required, a redundant-array-of-independent-disks (RAID) device has increasingly been used as a secondary storage device. The RAID device records data to a plurality of magnetic disks using a redundancy method such as a mirroring, so that even when one of the magnetic disks fails, it still is possible to continue an operation without losing the data (see, for example, Japanese Patent Application Laid-Open No. H7-129331).

In the RAID device, not only the magnetic disks but also controllers or other units for controlling data to be stored in the magnetic disks are set redundantly. The RAID device having such a configuration specifies a region suspected to be in failure by an autonomous coordinating operation between the controllers, and removes the suspected region to realize a higher reliability.

A specification of a failure region can be implemented with a technology disclosed in, for example, Japanese Patent Application Laid-Open No. 2000-181887. Namely, each controller regularly checks each path for each unit in a device, and performs statistical processing based on a failure in the path, thereby specifying the failure region. For example, when a failure is detected in a path A and consecutively detected in a path B by the check, a region shared by the path A and the path B can be determined as being in failure.

Recently, however, it has become possible to integrate a plurality of functions into a single functional unit to reduce costs. Because the number of components in a device can be reduced by integrating the various functions, it becomes possible to increase a reliability of the device. On the contrary, such a configuration causes a difficulty for specifying a failure region. Because the number of paths to be checked decreases due to the integration, it becomes difficult to clearly specify which region is in a failure on the path.

### SUMMARY OF THE INVENTION

It is an object of the present invention to at least partially solve the problems in the conventional technology.

A redundant-array-of-independent-disks control device according to one aspect of the present invention includes a plurality of control modules and a switch for connecting the control modules. Each of the control modules includes a failure monitoring unit that sends a check command for detecting a possible failure to other control modules via a predetermined path, and specifies a region suspected to be in failure based on a response to the check command and a status of a path or a region on the path indicated by the response.

A control device according to another aspect of the present invention includes a plurality of control modules and a switch for connecting the control modules. Each of the control modules includes a failure monitoring unit that sends a check command for detecting a possible failure to other control modules via a predetermined path, and specifies a region suspected to be in failure based on a response to the check command and a status of a path or a region on the path indicated by the response.

A failure monitoring method according to still another aspect of the present invention is for monitoring a failure in a control device that includes a plurality of control modules and a switch for connecting the control modules. The method includes sending including each of the control modules sending a check command for detecting a possible failure to other control modules via a predetermined path; and specifying a region suspected to be in failure based on a response to the check command and a status of a path or a region on the path indicated by the response.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic for explaining the concept of a failure monitoring method according to an embodiment of the present invention;

FIG. 2 is a block diagram for explaining a structure of a RAID control device according to the present embodiment;

FIG. 3 is a flowchart of an operation procedure of a master failure monitoring unit;

FIG. 4 is a flowchart of an operation procedure of a failure monitoring unit;

FIG. 5 is an example of the contents of logic for incrementing points based on a response status;

FIG. 6 is an example of the contents of logic for incrementing points based on combination of failure paths;

FIG. 7 is an example of the contents of a setting the point to be incremented based on the number of control modules;

FIG. 8 is a schematic for explaining the concept of a conventional failure monitoring method; and

FIG. 9 is an example of the contents of statistical processing.

### DETAILED DESCRIPTION OF THE PREFERRED EMBODIMENTS

Exemplary embodiments of the present invention are explained below in detail with reference to the accompanying drawings. The present invention is not limited to the embodiments.

FIG. 8 is a schematic for explaining the concept of a conventional failure monitoring method. A RAID control device 1 shown in FIG. 8 controls the entire RAID device, including a failure monitoring unit 21a, a failure monitoring unit 21b, and a switch 30 connecting the failure monitoring unit 21a and the failure monitoring unit 21b.

The failure monitoring unit 21a is connected to a host adaptor 22a that is an interface for connecting the RAID control device 1 the RAID control device 1 with a host computer, and to a disk adaptor 23a that is an interface for connecting the RAID control device 1 the RAID control device 1 with a hard disk device. Similarly, the failure monitoring unit 21b is connected to a host adaptor 22b and a disk adaptor 23b. Each adaptor includes a unique processor and can realize predetermined functions independently.

The failure monitoring unit 21a and the failure monitoring unit 21b include the same functions to realize a redundant structure so that when one of the control modules is suspected to be in failure, the other control module can perform processing alternately to the one of the control modules without interruption. To detect a failure, a control module 20a includes the failure monitoring unit 21a for monitoring a control module 20b, and the control module 20b includes the failure monitoring unit 21b for monitoring the control module 20a.

The failure monitoring unit 21a regularly sends a check command to a path 11 getting to the failure monitoring unit 21b via the switch 30, to a path 12 getting to the disk adaptor 23b via the switch 30, and to a path 13 getting to the host adaptor 22b via the switch 30, and records a result whether there is a response from each path.

Similarly, the failure monitoring unit 21b regularly sends a check command to paths getting to the failure monitoring unit 21a, to the host adaptor 22a, and to the disk adaptor 23a, and records a result whether there is a response from each path. Either the failure monitoring unit 21a or the failure monitoring unit 21b is used as a master failure monitoring unit. The master failure monitoring unit performs statistical processing of data recorded by each failure monitoring unit and when there is a region that is suspected to be in failure, the master failure monitoring unit controls a predetermined functional unit to perform a removal operation and the like for the region suspected to be in failure.

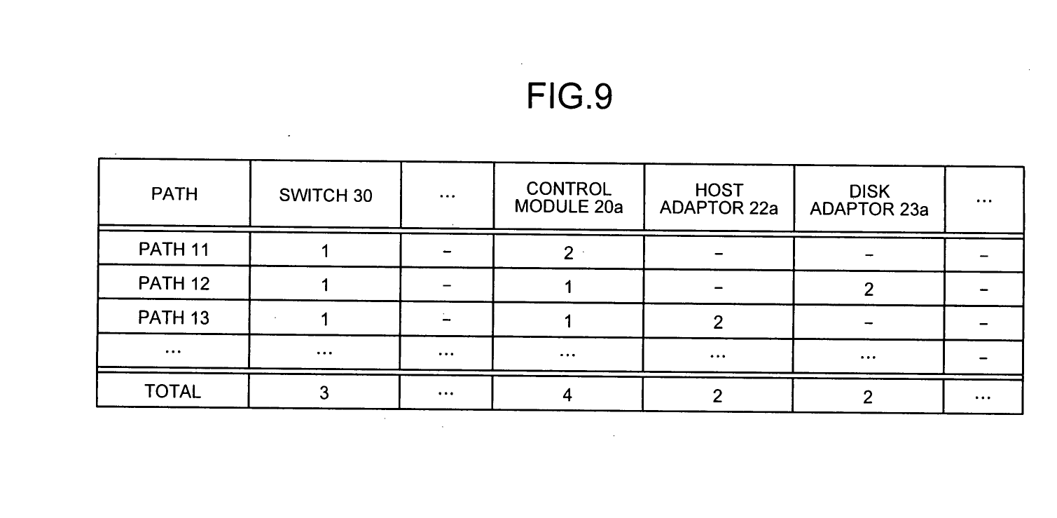

FIG. 9 is an example of the contents of the statistical processing. It is assumed that there are no responses to the check command sent to the path 11, the path 12, and the path 13. It is also assumed here that two points are to be incremented with respect to each end unit of each path, and one point is to be incremented with respect to each region on each path. For example, with regard to the path 11, one point is incremented with respect to the switch 30 and two points are incremented with respect to the control module 20a. Similarly, with regard to the path 12, one point is incremented with respect to the switch 30 and the control module 20a, and two points are incremented with respect to the disk adaptor 23a. With regard to the path 13, one point is incremented with respect to the switch 30 and the control module 20a, and two points are incremented with respect to the host adaptor 22a. As a result, total points of the switch 30 becomes three, of the control module 20a becomes four, of the host adaptor 22a becomes two, and of the disk adaptor 23a becomes two.

The master failure monitoring unit collects information recorded by each failure monitoring unit regarding whether there is a response to the check command for the path. Thereafter, the master failure monitoring unit sums up points that are incremented according to the response with respect to each region. When total points of a region become more than a predetermined threshold in a predetermined time, it is determined that the region is suspected to be in failure. Thus, the region suspected to be in failure can be proactively detected, and the detected region can be removed so as not to be used in the operation, to realize a stable operation in a device.

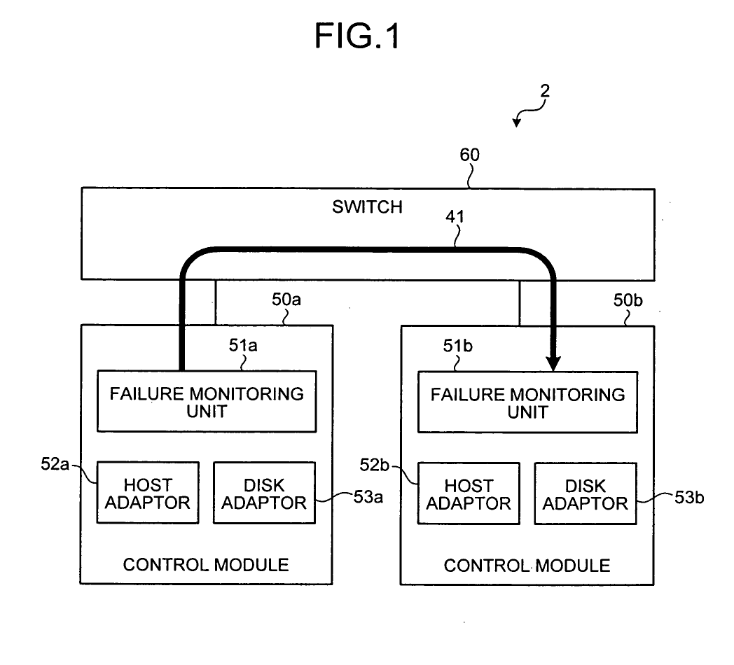

FIG. 1 is a schematic for explaining the concept of a failure monitoring method according to an embodiment of the present invention. A RAID control device 2 controls the entire RAID device, including a control module 50a, a control module 50b, and a switch 60 connecting the control module 50a and the control module 50b to realize various controls to a disk array.

The control module 50a includes a built-in host adaptor 52a having the same functions as that of the host adaptor 22a , and includes a built-in disk adaptor 53a having the same functions as that of the disk adaptor 23a. Similarly, the control module 50b includes a built-in host adaptor 52b and a built-in disk adaptor 53b. Above configuration of built-in adaptors is made for reducing costs and improving reliability.

The control module 50a and the control module 50b include the same functions to realize a redundant structure so that when one control module is suspected to be in failure, the other control module can alternately perform processing of the one control module without interruption. To detect a failure, the control module 50a includes a failure monitoring unit 51a for monitoring the control module 50b, and the control module 50b includes a failure monitoring unit 51b for monitoring the control module 50a.

The failure monitoring unit 51a regularly sends a check command to a path 41 getting to the failure monitoring unit 51b via the switch 60, and records a result whether there is a response from the path 41. With a configuration shown in FIG. 1, the host adaptor 52b and the disk adaptor 53b are integrated in the control module 50b; thereby the host adaptor 52b and the disk adaptor 53b do not perform operations independently. Therefore, paths for monitoring the host adaptor 52b and the disk adaptor 53b are omitted. Similarly, the failure monitoring unit 51b regularly sends a check command to a path getting to the failure monitoring unit 51a via the switch 60, and records a result whether there is a response from the path.

As described above, because there are only two paths, it is difficult to clearly specify a region suspected to be in failure by performing a statistical processing based only on an existence of a response to a check command. In the failure monitoring method according to the embodiment, a region suspected to be in failure is specified based not only on the existence of the response to the check command, but also on contents' of the response to the check command.

For example, when a load increases in a control module used as a destination of a check command, and if the control module cannot allocate memory or other resources, there returns a response that indicates difficulties for performing check command processing. In this case, a switch on the path can be determined as being in normal condition. On the other hand, the control module can be determined as being in failure based on the returned response.

As described above, a region suspected to be in failure is determined based not only on the existence of a response to a check command, but also on contents of the response to the check command, thereby enabling to sufficiently clearly specify the region suspected to be in failure even when only a few paths are acquired, due to an integration of functions, for monitoring an occurrence of a failure.

In FIG. 1, the failure monitoring method according to the present embodiment is applied to a RAID control device having a simple redundant structure containing two control modules connected with a single switch. However, the failure monitoring method can also be applied to other RAID control devices having more complicated configurations. Further, although a switch is used for connecting the two control modules in FIG. 1, a bus can also be used for connecting the control modules. The failure monitoring method is not limited to be applied to RAID control devices, and can be applied to other devices containing a plurality of control modules or operating modules.

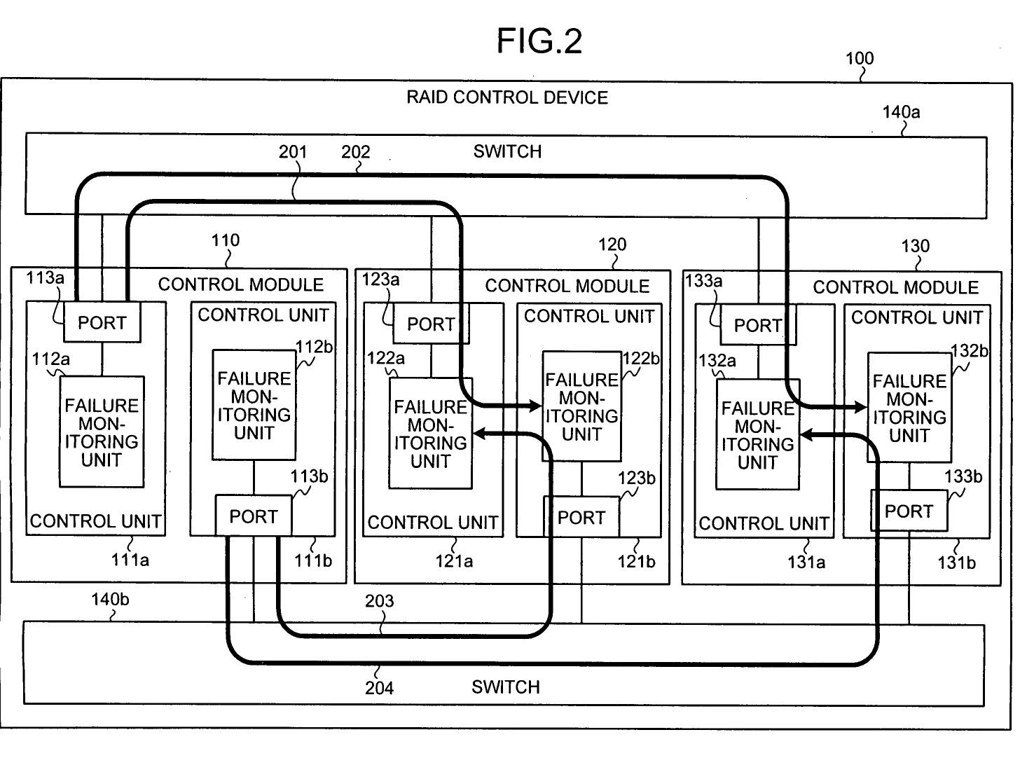

FIG. 2 is a block diagram for explaining a structure of another RAID control device according to the present embodiment. In FIG. 2, only a configuration related to monitoring an occurrence of a failure is depicted and other configurations of functional units for controlling a disk array are omitted.

A RAID control device 100 includes a control module 110, a control module 120, and a control module 130. The control module 110 includes a control unit 111a and a control unit 111b, each of which can perform operations independently. Similarly, the control module 120 includes a control unit 121a and a control unit 121b, and the control module 130 includes a control unit 131a and a control unit 131b. The control unit 111a, the control unit 121a, and the control unit 131a are connected via a switch 140a, while the control unit 111b, the control unit 121b, and the control unit 131b are connected via a switch 140b.

The control unit 111a includes a failure monitoring unit 112a for monitoring an occurrence of a failure in other control modules, and a port 113a used as an interface for connecting the failure monitoring unit 112a to the switch 140a. Similarly, the control unit 111b includes a failure monitoring unit 112b and a port 113b, the control unit 121a includes a failure monitoring unit 122a and a port 123a, the control unit 121b includes a failure monitoring unit 122b and a port 123b, the control unit 131a includes a failure monitoring unit 132a and a port 133a, and the control unit 131b includes a failure monitoring unit 132b and a port 133b.

The RAID control device 100 removes a region highly suspected to be in failure in units of control module, port, and switch so that operations can stably be performed without interruption. Each failure monitoring unit regularly sends a check command to a predetermined path to specify a region suspected to be in failure.

The failure monitoring unit 112a regularly sends a check command to a path 201 getting to the failure monitoring unit 122b via the port 113a, the switch 140a, the port 123a, and the failure monitoring unit 122a , and monitors an occurrence of a failure in the control module 120. The failure monitoring unit 112a regularly sends a check command to a path 202 getting to the failure monitoring unit 132b via the port 113a, the switch 140a, the port 133a, and the failure monitoring unit 132a , and monitors an occurrence of a failure in the control module 130.

The failure monitoring unit 112b regularly sends a check command to a path 203 getting to the failure monitoring unit 122a via the port 113b, the switch 140b, the port 123b, and the failure monitoring unit 122b , and monitors an occurrence of a failure in the control module 120. The failure monitoring unit 112b regularly sends a check command to a path 204 getting to the failure monitoring unit 132a via the port 113b, the switch 140b, the port 133b, and the failure monitoring unit 132b , and monitors an occurrence of a failure in the control module 130. Similarly, other control modules also regularly send check commands to predetermined paths.

With the above configuration, when the failure monitoring unit 112a monitors an occurrence of a failure in the control module 120, it becomes possible to check all regions necessary to be monitored in the control module 120 by sending a check command to a path getting to the failure monitoring unit 122a via the port 113a, the switch 140a, and the port 123a, and to another path getting to the failure monitoring unit 122a via the port 113b, the switch 140b, the port 123b, and the failure monitoring unit 122b.

However, compared with the configuration shown in FIG. 2, the number of paths for sending a check command to the same failure monitoring unit becomes doubled, thereby increasing load and decreasing efficiency. Further, the two different paths to the same failure monitoring unit have two different lengths, thereby necessary for managing time-out period with respect to each path. As a result, operations become more complicated.

Upon using the path shown in FIG. 2, it becomes possible to use a minimal number of paths for sending check command from one failure monitoring unit to another failure monitoring unit, and the lengths of the paths used at each failure monitoring unit can be technically equal. When there does not is a response to a check command sent from a first failure monitoring unit, it becomes possible to specify whether a region suspected to be in failure is in a switch or in a control module, by verifying a response to a check command sent from a second failure monitoring unit of the second control unit in the same control module.

When there is no response from a first path getting to a control module, and if there is no response from a second path, of a failure monitoring unit in other control unit, getting to the same control module, the control module can be determined as being in failure. On the other hand, when there is no response from the first path getting to a control module, and if there is a response from the second path, of the failure monitoring unit in the other control unit, getting to the same control module, a switch can be determined as being in failure.

The operation procedure of the failure monitoring unit is generally divided into two operation procedures. A first operation procedure is for sending a check command to a predetermined path, specifying a region suspected to be in failure based on an existence of a response to the check command, and incrementing points based on the suspected region. A second operation procedure is for summing up the incremented points with respect to the suspected region, and determining whether there is a failure in the suspected region based on the sum of points. The second operation procedure is performed only by a single failure monitoring unit (hereinafter, “master failure monitoring unit”) that is in a normal operation status.

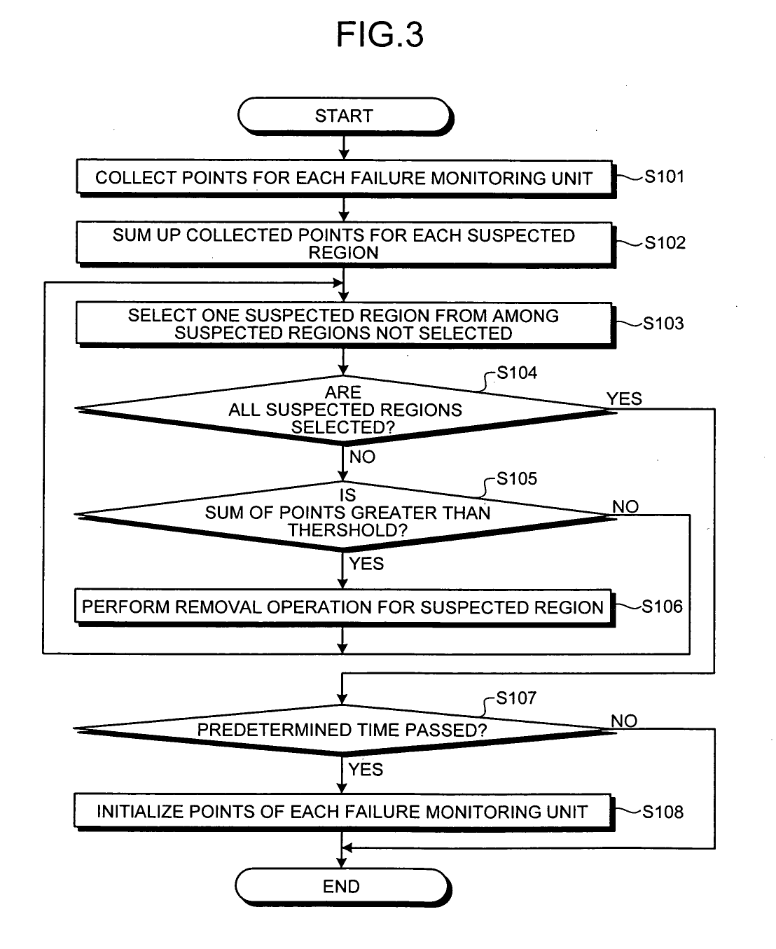

FIG. 3 is a flowchart of an operation procedure of the master failure monitoring unit. The master failure monitoring unit regularly repeats the operation procedure after finishing a predetermined initializing operation. The master failure monitoring unit collects incremented points with respect to each failure monitoring unit (step S101), and sums up the collected points with respect to a region suspected to be in failure (step S102). An operation procedure for recording the incremented points with respect to each failure monitoring unit is explained later.

The master failure monitoring unit selects a region that is not yet selected from among the suspected regions (step S103). When all the suspected regions are selected (YES at step S104), the process control proceeds to step S107. When there is a suspected region not yet selected (NO at step S104), the master failure monitoring unit determines whether a total point of the suspected region is more than a predetermined threshold. When the total point is more than the predetermined threshold (YES at step S105), the master failure monitoring unit determines the suspected region as being in failure, and controls a predetermined functional unit to perform a removal operation to the suspected region (step S106). Thereafter, process control returns to step S103. On the other hand, when the total point is less than the predetermined threshold (NO at step S105), process control returns to step S103 without performing operations to the suspected region.

After verifying total points corresponding to all the suspected regions, when a predetermined time has passed since the operation started, or since the former incremented points were initialized (YES at step S107), the master failure monitoring unit performs an operation for initializing incremented points to zero with respect to each unit (step S108).

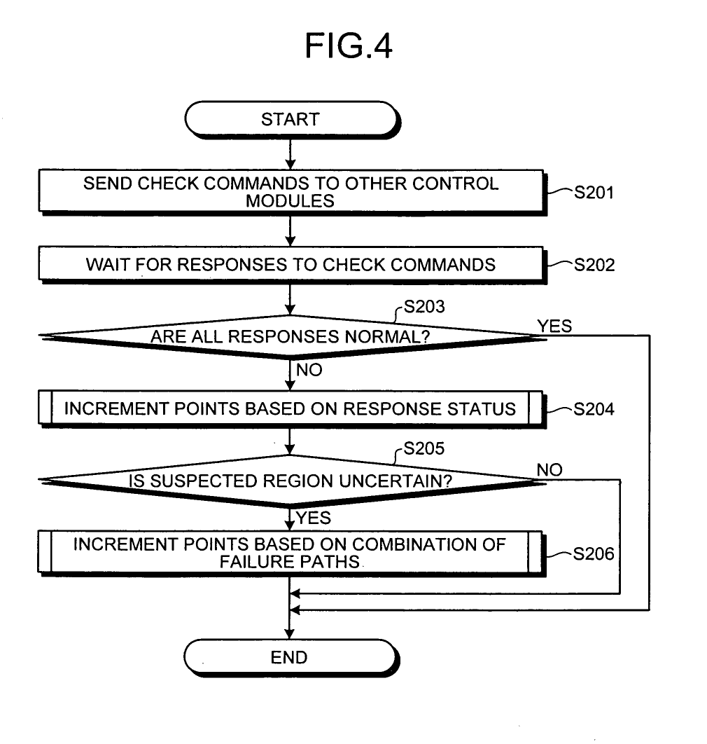

FIG. 4 is a flowchart of an operation procedure of the failure monitoring units shown in FIG. 2. The failure monitoring units including the master failure monitoring unit regularly repeat the operation after finishing a predetermined initializing operation. The operation procedure shown in FIG. 4 is performed in shorter period than the operation procedure shown in FIG. 3. Each failure monitoring unit sends check commands to each path getting to another control module (step S201), and waits for responses to be returned (step S202). When all responses are normal (YES at step S203), the failure monitoring units do not perform operations for incrementing points based on the responses. When at least one response is abnormal (NO at step S203), the failure monitoring units perform operations for incrementing points based on a response status explained later (step S204). When there still is a path in which a suspected region cannot be specified even by performing operations for incrementing points (YES at step S205), the failure monitoring units perform operations for incrementing points based on combination of failure paths explained later (step S206).

FIG. 5 is an example of the contents of logic for incrementing points based on a response status. In an operation for incrementing points based on the response status, a suspected region and a corresponding size of a point to be incremented are associated with a class of the response status included in a response to a sent check command, and the operation for incrementing points is performed according to the association.

When the response status indicates that a control module used as a destination of a check command (hereinafter, “other control module”) is blocked, it can be assumed that a removal operation has been performed to the other control module and the other control module has been separated from a switch. However, as a precaution, large point is incremented to the other control module.

When the response status indicates that a path is blocked, it can be assumed that a removal operation has been performed to at least one unit on the path and the unit has been separated. However, as a precaution, small point is incremented to a port of a control unit including the failure monitoring unit performing the operation for incrementing points (hereinafter, “own port”), to a switch on the path, and to a port of a control module used as a destination of a check command (hereinafter, “other port”).

In this case, if only the other control module is not removed, points can be incremented only to the switch on the path. This is because, if the switch is removed, other modules are to be separated from the switch and not affected by the switch.

When the response status indicates that a control module including the failure monitoring unit performing the operation for incrementing points (hereinafter, “own module”) is in abnormal status, it can be assumed that points have been incremented to the own port by other failure monitoring unit. However, as a precaution, small point is incremented to the own module.

When the response status indicates that the other control module cannot perform necessary operations because of a resource depletion such as memory depletion, small point is incremented to the other control module in case there is a failure. In this case, it can be assumed that each unit on the path is in normal status, and therefore, a response can be assumed as normal.

When the response status indicates that the own module cannot perform necessary operations because of a resource depletion such as memory depletion, small point is incremented to the own module in case there is a failure. In this case, it is assumed that a check command has not been sent.

When the response status indicates that transceiving a check command cannot be properly performed due to a parameter error, it is because there is a bug or a mismatch in a firmware, points are not incremented to units, and it is assumed that the check command has not been sent.

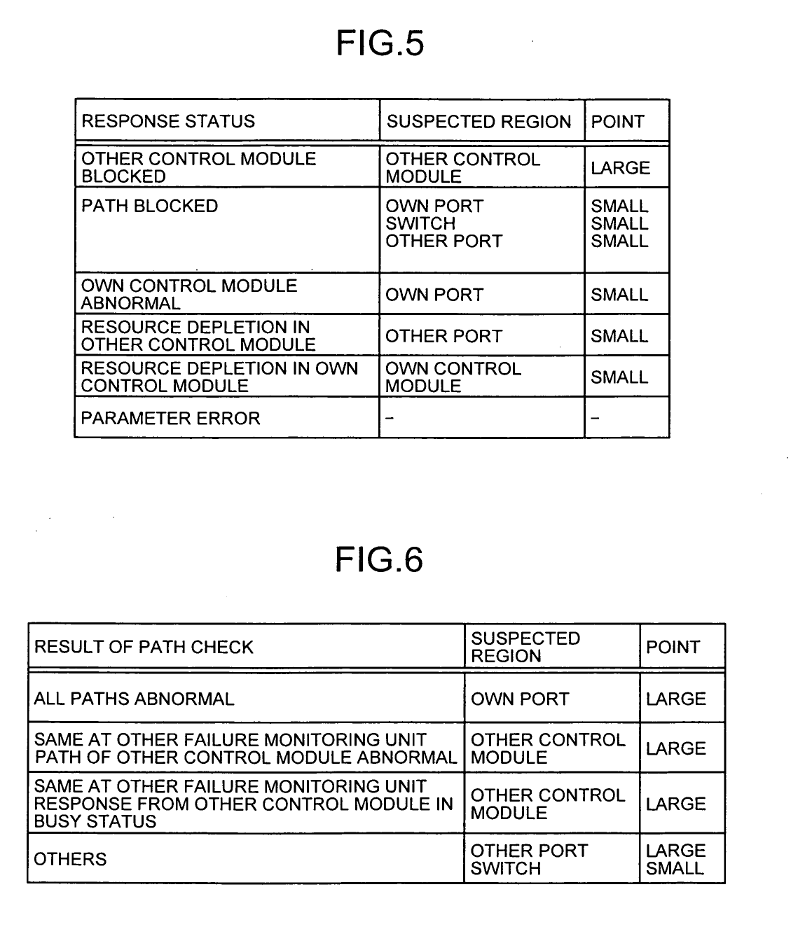

FIG. 6 is an example of the contents of logic for incrementing points based on combination of failure paths. In an operation for incrementing points based on combination of failure paths, a region suspected to be in failure and corresponding point to be incremented are predetermined with respect to a combination pattern of a path that has not returned a normal response, and the operation for incrementing points based on combination of failure paths is performed according to the predetermined logic. The operation is performed when there is a path having a response status that does not correspond to any classes shown in FIG. 5.

When there all the paths to which the failure monitoring unit has sent a check command is in abnormal status, large point is incremented to the own port because it is assumed that the own port is in abnormal status.

Upon verifying other failure monitoring unit in the own module and the paths being in abnormal status, and there a path getting to the same control module is in abnormal status, large point is incremented to the other control module because it is assumed that the other control module is in abnormal status.

Upon verifying other failure monitoring unit in the own module and the paths being in abnormal status, and even when other path, to the same control module, in other failure monitoring unit, is in normal status, if the response of the path includes information indicating that the other control module is in busy status, large point is incremented to the other control module because it is assumed that the other control module is in abnormal status. The control units in the same control module are configured to perform a regular check with each other whether the control unit is in active status, and if the check is not properly performed, the status is determined as busy status.

In cases other than the above explained cases, large point is incremented to the other port of a path that is in abnormal status, and small point is incremented to a switch on the path. In this case, if only the other control module is not removed from the operation, points can be incremented only to the switch on the path. This is because, if the switch is removed from the operation, other modules are to be separated from the switch and not affected by the switch.

In the operation for incrementing points based on the response status and the operation for incrementing points based on combination of failure paths, total points become larger along with the increase of a number of the control modules monitored with each other. For example, assuming that the RAID control device 100 shown in FIG. 2 has a configuration that enables to increment more control modules therein, and if three control modules are incremented resulting in totally six control modules are set therein, total points of the incremented points with respect to each unit becomes almost double, in a single operation for incrementing points based on the response status or in a single operation for incrementing points based on combination of failure paths.

When a failure has occurred, and if a half of the control modules has become removed, total points of the incremented points with respect to each unit becomes almost half, in a single operation for incrementing points based on the response status or in a single operation for incrementing points based on combination of failure paths. To prevent an occurrence of disparity of detection ability for specifying a region suspected to be in failure, caused by a variation of the total points according to an increase or a decrease of the number of the control modules, it is effective to make a variation in a size of points to be incremented according to the number of the control modules.

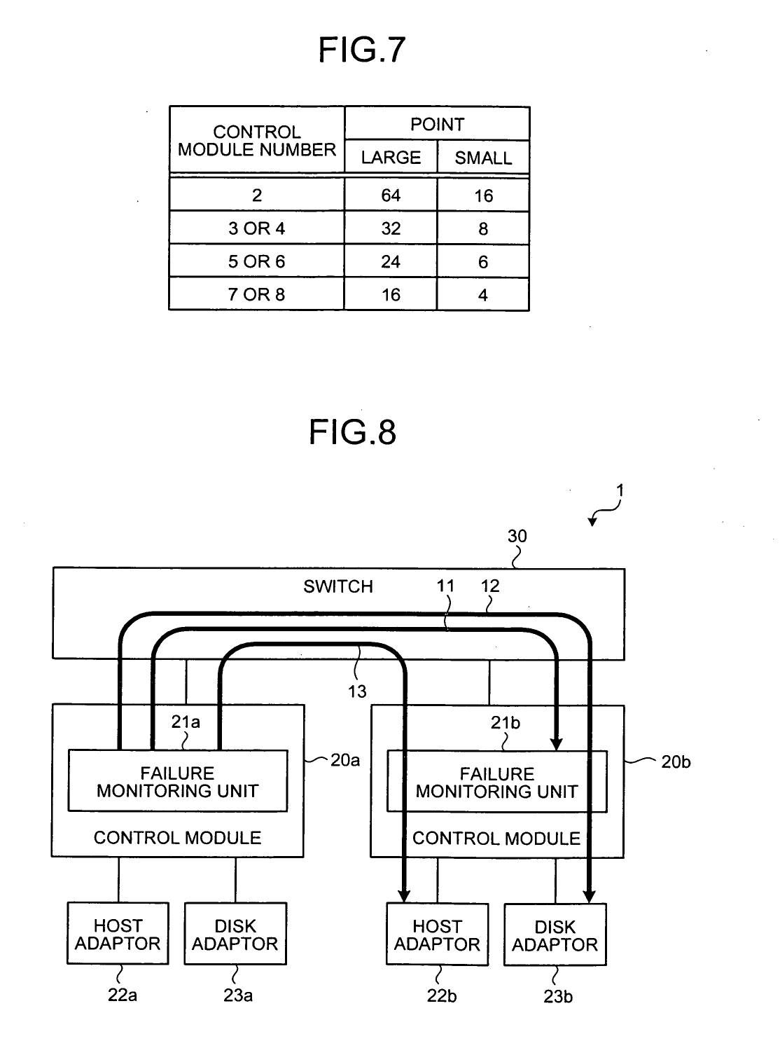

FIG. 7 is an example of the contents of logic for determining size of points to be incremented based on number of control modules. For example, when the number of the control module is two, large point to be incremented is 64 while small point to be incremented is 16. When the number of the control module is three or four, large point to be incremented is 32 while small point to be incremented is 8. When the number of the control module is five or six, large point to be incremented is 24 while small point to be incremented is 6. When the number of the control module is seven or eight, large point to be incremented is 16 while small point to be incremented is 4. Instead of changing a size of the points to be incremented according to the number of the control modules, it is also effective to change a threshold for determining whether a suspected region is in failure.

According to an embodiment of the present invention, it is configured that a region suspected to be in failure is specified based on an existence of a response to a check command sent to the paths and based on the contents of the response, so that even with insufficient number of paths for sending the check command, the region suspected to be in failure can be sufficiently clearly specified.

Furthermore, according to an embodiment of the present invention, it is configured that a region suspected to be in failure is specified based on a difference of responses between a plurality of paths getting to the same target unit, so that even with insufficient number of paths for sending the check command, it is effective to specify whether the region suspected to be in failure is on the paths or in the target unit.

Moreover, according to an embodiment of the present invention, it is configured that points are incremented with respect to a region suspected to be in failure according to the number of control modules monitored with each other, and a target unit is selected for performing a removal operation thereto, so that regardless of the number of the control modules monitored with each other, detection ability for specifying the target unit to be in a removal operation can become stable.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A redundant-array-of-independent-disks control device that includes a plurality of control modules and a switch for connecting the control modules, wherein
each of the control modules includes a failure monitoring unit that sends a check command for detecting a possible failure to other control modules via a predetermined path, and specifies a region suspected to be in failure based on a response to the check command and a status of a path or a region on the path indicated by the response.

2. The redundant-array-of-independent-disks control device according to claim 1, wherein
when the response indicates that it is not possible to process the check command because of a resource depletion, the failure monitoring unit specifies a region including a transmission source of the response as the region suspected to be in failure.

3. The redundant-array-of-independent-disks control device according to claim 1, wherein
when the check command is sent to same control module via a plurality of paths, the failure monitoring unit specifies the region suspected to be in failure based on a difference between responses returned from each of the paths.

4. The redundant-array-of-independent-disks control device according to claim 1, wherein
the failure monitoring unit records a predetermined point for the region suspected to be in failure based on number of control modules monitoring each other, collects the recorded points including points recorded by other failure monitoring units for each region, and selects a region with the collected point greater than a threshold as an object of removing.

5. A control device that includes a plurality of control modules and a switch for connecting the control modules, wherein
each of the control modules includes a failure monitoring unit that sends a check command for detecting a possible failure to other control modules via a predetermined path, and specifies a region suspected to be in failure based on a response to the check command and a status of a path or a region on the path indicated by the response.

6. The control device according to claim 5, wherein
when the response indicates that it is not possible to process the check command because of a resource depletion, the failure monitoring unit specifies a region including a transmission source of the response as the region suspected to be in failure.

7. The control device according to claim 5, wherein
when the check command is sent to same control module via a plurality of paths, the failure monitoring unit specifies the region suspected to be in failure based on a difference between responses returned from each of the paths.

8. The control device according to claim 5, wherein
the failure monitoring unit records a predetermined point for the region suspected to be in failure based on number of control modules monitoring each other, collects the recorded points including points recorded by other failure monitoring units for each region, and selects a region with the collected point greater than a threshold as an object of removing.

9. A method of monitoring a failure in a control device that includes a plurality of control modules and a switch for connecting the control modules, the method comprising:
sending including each of the control modules sending a check command for detecting a possible failure to other control modules via a predetermined path; and
specifying a region suspected to be in failure based on a response to the check command and a status of a path or a region on the path indicated by the response.

10. The method according to claim 9, wherein
when the response indicates that it is not possible to process the check command because of a resource depletion, the specifying includes specifying a region including a transmission source of the response as the region suspected to be in failure.

11. The method according to claim 9, wherein
when the check command is sent to same control module via a plurality of paths, the specifying includes specifying the region suspected to be in failure based on a difference between responses returned from each of the paths.

12. The method according to claim 9, further comprising:
recording a predetermined point for the region suspected to be in failure based on number of control modules monitoring each other;
collecting the recorded points including points recorded by other failure monitoring units for each region; and
selecting a region with the collected point greater than a threshold as an object of removing.
